(19) United States
(12) Patent Application Publication
(10) Pub. No.: US 2010/0043920 A1
(43) Pub. Date: Feb. 25, 2010

(54) DISPENSER

(75) Inventor: Akira Higuchi, Fukuoka (JP)

Correspondence Address: PEARNE & GORDON LLP, 1801 EAST 9TH STREET, SUITE 1200, CLEVELAND, OH, 44114-3108, US

(73) Assignee: Panasonic Corporation, Osaka (JP)

(21) Appl. No.: 12/441,647

(22) PCT Filed: Nov. 27, 2007
(86) PCT No.: PCT/JP2007/073284

§ 371 Date: Mar. 17, 2009

(30) Foreign Application Priority Data
Nov. 27, 2006 (JP) 2006-318261

(51) Int. Cl. B67C 3/00

(52) U.S. Cl. 141/192

(57) ABSTRACT

A dispensing head 4 which moves relatively to a sample vessel 8 to dispense a sample into the sample vessel is provided with lid traps 32. The lid traps 32 have arms 38 freely swingable for the dispensing head 4 and sucking pads 39 formed on the lower ends of the arms 38, respectively. The arms 38 are swung by a lid trap swinging cylinder 24 thereby to move the lid 9 trapped by sucking using the sucking pads 39 sideward of the dispensing head 4.

### TECHNICAL FIELD

This invention relates to a dispenser for dispensing a sample employed in the fields of screening of created medicines, biotechnology and medical science.

### BACKGROUND ART

As a device for systematically executing a test such as a biochemical reaction of a material, there is known a dispenser for dispensing a sample such as a reagent or a liquid medicine into a sample vessel such as a microtiter plate with multiple wells arranged in a grid pattern. The dispenser is provided with a dispensing head with plural nozzles for sample dispensing on a movable moving stage. The dispensing head moves above the sample vessel to dispense the sample into the sample vessel.

In order to prevent dust from being mixed into the wells, as the case may be, the sample vessel is equipped with a removable lid. In dispensing for such a lid-equipped sample vessel, prior to dispending, the lid must be removed from the sample vessel. To this end, there is a known dispenser in which a lid attaching/detaching device for attaching/detaching the lid is attached onto the moving stage, separately from the dispensing head.

[Patent Reference 1] JP-A-2005-300200

[Patent Reference 2] JP-A-9-281115

However, in the dispenser in which the lid attaching/detaching device is provided separately from the dispensing head as described above, the dispensing head and the lid attaching/detaching device must be moved so that they do not interfere with each other. As a result, the operation of the dispensing head and that of the lid attaching/detaching device are complicatedly confused, thereby deteriorating the efficiency. Further, the lid removed from the sample vessel by the lid attaching/detaching is not necessarily returned to the sample vessel so that the sample put on the lid may be mixed into another sample.

### DISCLOSURE OF THE INVENTION

Thus, an object of this invention is to provide a dispenser which can efficiently dispense a sample into lid-equipped sample vessel and prevent the sample put on the lid from being mixed into another sample.

According to the invention, a dispenser for dispensing a sample in a sample vessel equipped with a removable lid in a state where the lid is removed, comprising: a dispensing head for dispensing the sample into the sample vessel by its movement relative to the sample vessel; a lid trap attached to the dispensing head for trapping the lid; and a lid trap driving means for driving the lid trap to move the lid trapped by the lid trap sideward of the dispensing head.

Additionally, the lid trap has an arm swingable for the dispensing head, and the lid trap driving means swings the arm for the dispensing head thereby to move the lid tapped by the lid trap sideward of the dispensing head.

Additionally, when the arm is driven by the lid trap driving means to swing for the dispensing head, it operates to bring the trapped lid near to the dispensing head.

Additionally, the lid trap traps the lid through sucking by a sucking piece formed at the lower end of the arm.

Additionally, the arm is provided as a pair of arms on both sides of the dispensing head, and an arm opening/closing means is provided to open/close the lower ends of the pair of arms to sandwich the sample vessel.

In accordance with the dispenser according to this invention, while the sample is dispensed into the sample vessel by the dispensing head, the lid trapped by the lid trap prior to dispensing can be left moved (retreated) sideward of the dispensing head. Thus, a series of operations from removal of the lid prior to dispensing to the dispensing and return of the lid after the dispensing can be smoothly performed so that the dispensing for the sample vessel equipped with the lid can be done effectively in a short time. Further, since the lid removed from the sample vessel prior to the dispensing is necessarily returned to the original sample vessel, the sample within the sample vessel put on the lid will not be mixed in another sample.

### BRIEF DESCRIPTION OF THE DRAWINGS

FIG. 1 is a perspective view of the dispenser according to an embodiment of this invention.

FIG. 2 is a perspective view of a sample vessel and lid according to an embodiment of this invention.

FIG. 3 is a front view of a dispensing head according to an embodiment of this invention.

FIG. 4 is a side view of a dispensing head according to an embodiment of this invention.

FIG. 5 is a block diagram showing a control system of the dispensing head according to this invention.

FIG. 6 is a front view of a dispensing head according to an embodiment of this invention.

FIG. 7 is a front view of a dispensing head according to an embodiment of this invention.

FIG. 8 is a front view of a dispensing head according to an embodiment of this invention.

FIG. 9 is a front view of a dispensing head according to an embodiment of this invention.

FIG. 10 is a front view of a dispensing head according to an embodiment of this invention.

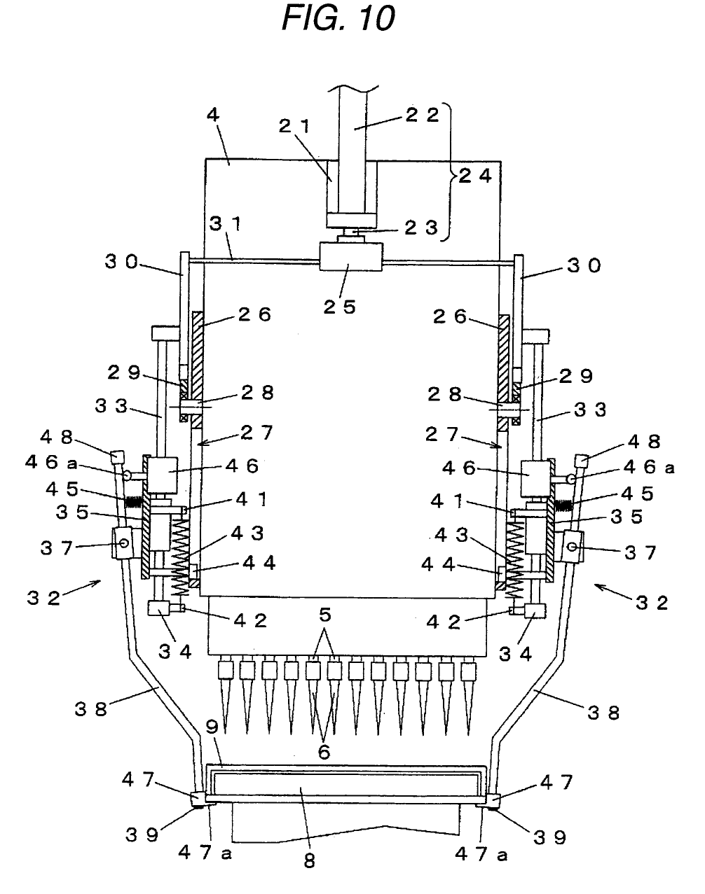

### BEST MODE FOR CARRYING OUT THE INVENTION

Now, referring to the drawings, an explanation will be given of an embodiment of this invention.

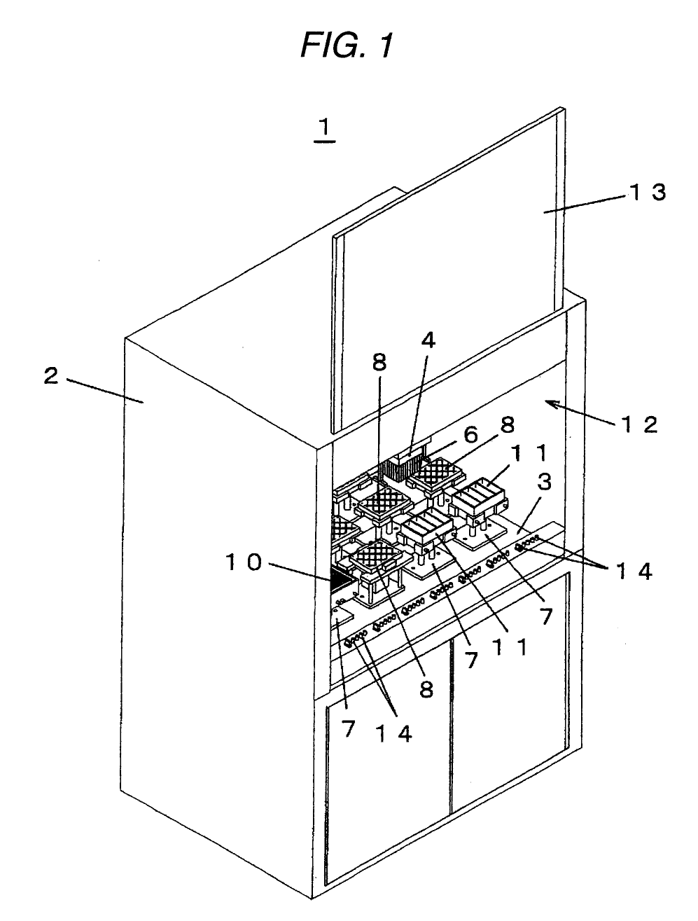

Referring to FIG. 1, a dispenser 1 includes a box-shape hollow cover member 2, a table provided within the cover member 2, and a dispensing head 4 attached to a moving stage (not shown) freely movable above the table 3. The dispensing head 4 has multiple nozzles 5 extended downward for sample dispensing. A conical hollow dip 6 is mounted in each of the nozzles 5.

On the upper surface of the table 3, plural working stages 7 are provided. The working stages 7 are a sample vessel placing stage for placing a sample vessel (e.g. microtiter plate) 8 into which the sample such as a reagent or liquid medicine is dispensed from the dispensing head 4, a cleaning stage 10 for cleaning the tip of the nozzle or dip 6, a cooling stage for cooling the sample or reagent supplied by a reservoir 11 and a stirring stage for stirring the solution contained in the vessel. These working stages 7 selected according to a dispensing operation are placed on the table 3.

On the front face of the cover member 2, an accessing opening 12 for accessing the table 3 from outside of the dispenser 1 is provided. The accessing opening 12 can be freely opened/closed by a shutter member 13 which ascends or descends along the cover member 2. At the lower edge of the accessing opening 12, connectors 14 of various kinds of cables of electric wires and conduits connected to the working stages 7 and others are collected at the same spot to be oriented in the same direction.

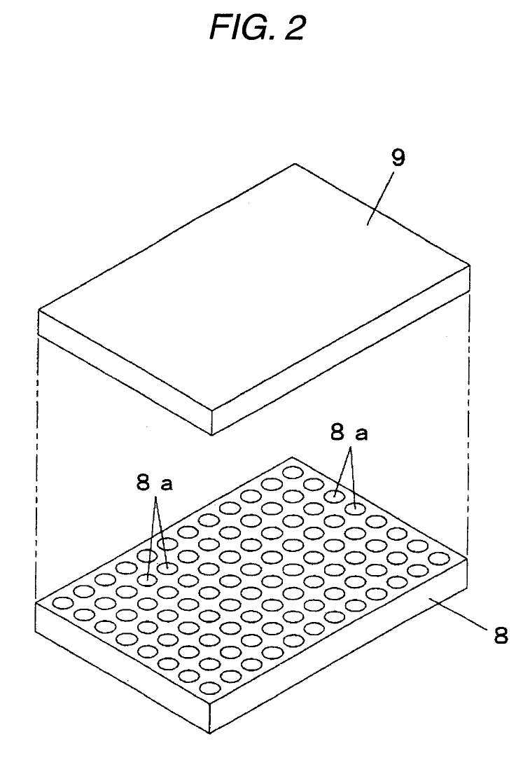

Referring to FIG. 2, a plurality of wells 8a are arranged in a grid pattern in the sample vessel 8. A lid 9 is removably placed to overlie the upper part of these wells 8a. The nozzles 5 of the dispensing head 4 are two-dimensionally arranged so as to correspond to the arrangement of these wells 8a.

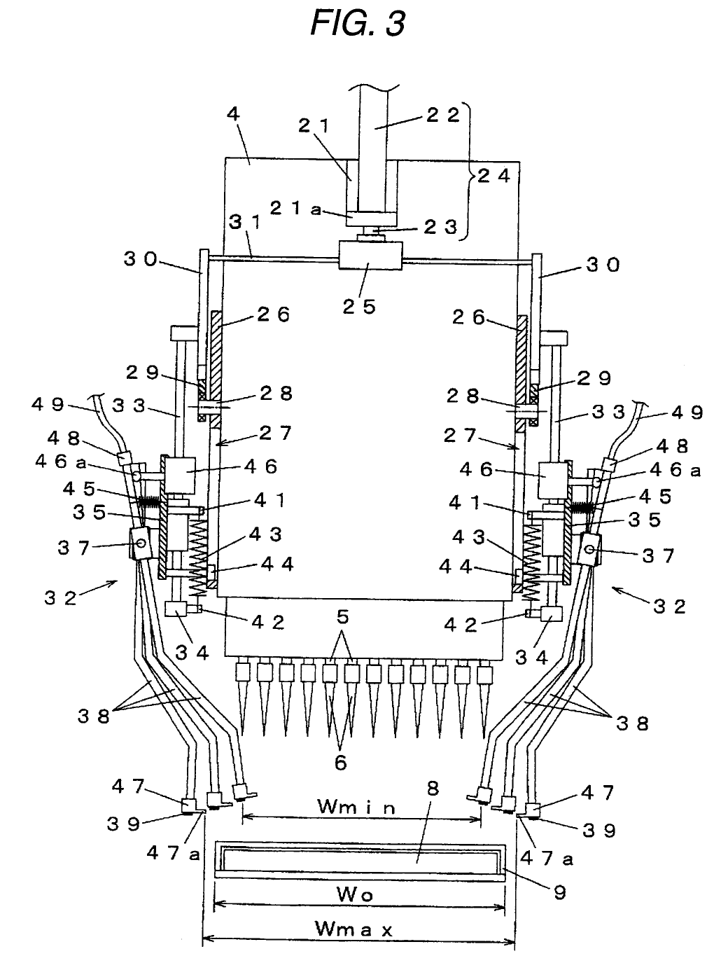

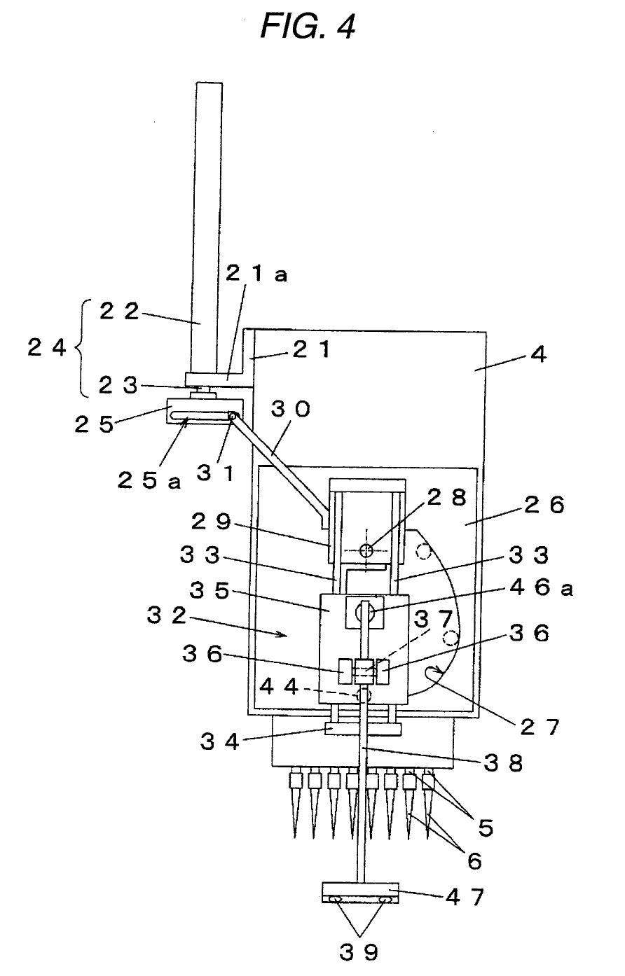

Referring to FIGS. 3 and 4, to the upper place of the front surface (this side of a paper face in FIG. 3) of the dispensing head 4, metal fittings 21 L-shaped in section are attached. To the upper surface of a horizontal portion 21a of the metal fittings 21, the lower end of a body 22 of a lid trap swinging cylinder 24 is fixed. A rod 23 is inserted in the body 22 and penetrates the horizontal portion 21a of the metal fitting 21 to protrude downward. The body 22 and rod 23 constitute the lid trap swinging cylinder 24.

To the lower end of the rod 23, a block 25 is attached. The block 25 has a slot groove 25a extended in a back-and-forth direction of the dispensing head 4 so as to penetrate in the right-and-left direction of the dispensing head 4.

On both right and left sides of the dispensing head 4, cams 26 are attached, respectively. For each of the cam plates 26, an arc-shaped cam groves 27 is provided. The cam plate 26 has a pivoting pin 28 protruding outward in the right-and-left direction of the dispensing head 4. To the pivoting pin 28, a swinging plate 29 is attached swingably within a back-and-forth plane of the dispensing head 4 (within the plane in parallel to the paper face of FIG. 4).

To the swinging plate 29, the lower end of a lever 30 extended aslant forward-upward of the dispensing head 4 is fixed. The upper ends of the levers 30 are pivoted at both ends of a horizontal member 31 horizontally extended in the slot groove 25a of the block 25 in the right-and-left direction of the dispensing head 4. Thus, if the lid trap swinging cylinder 24 operates so that the rod 23 moves vertically for the body 22 and the block 25 thereby ascends/descends, the right and left levers 30 swing the pair of swinging plates 29 around the pivoting pins 28 while moving, within the slot groove 25a, the horizontal member 31 connecting the upper ends of the levers 30 to each other.

The swinging plates 29 are provided with lid traps 32, respectively. Each lid trap 32 includes two parallel rails 33 extended from the swinging plate 29, a coupler 34 coupling the lower ends of these two rails 33, a slide plate 35 sliding along the rails 33, an arm supporting shaft 37 with both ends supported by supporting shaft supports 36 provided to the outer face of the slide plate 35, an arm 38 which is supported in its intermediate part by the arm supporting shaft 37 and extend in the vertical direction of the dispensing head 4 to be swingable in the right-and-left direction of the dispensing head 4, and sucking pads (sucking pieces) 39 attached to the lower end of the arm 38.

Referring to FIG. 3, a slide plate urging spring 43 is hung over between a first spring securing piece 41, extended so as to protrude inward from the slide plate 35 (toward the center of the dispensing head 4), and a second spring securing piece 42, extended inward from the coupler 34. Thus, although each slide plate 35 is urged by the slide plate urging spring 43 to move toward the coupler 34, since a cam follower 44 extended to protrude inward from the slide plate 35 is located with a cam groove 27, the slide plate 35 maintains the cam follower 44 in a state kept in contact with the inner peripheral edge of the cam groove 27.

Between the upper part of each arm 38 with respect to the arm supporting shaft 37 and the slide plate 35, an arm urging spring 45 is hung over. By this arm urging spring 45, each arm 38 is normally urged in a direction in which its lower end moves outwardly (in the direction in which the distance between the lower ends of both arms 38 extend from each other).

Each slide plate 35 is provided with an arm opening/closing cylinder 46 with its piston 46a oriented outward. The piston 46a of the arm opening/closing cylinder 46 is kept in contact with the upper end of the arm 38. So, if the arm opening/closing cylinder 46 gradually projects the piston 46a outward of the dispensing head 4, the arm 38 swings against the urging force of the arm urging spring 45 to inwardly move its lower end (toward the center of the dispensing head 4).

Referring to FIG. 3, the arms 38 bend inwardly in their lower part with respect to the arm supporting shaft 37, and at their lower ends, end lids 47 are attached, respectively. Each end lid 47 has a projection 47a projected inwardly. On the lower face of the end lid 47, plural sucking pads 39 are arranged in the back-and-forth direction of the dispensing head 4 in a state where the sucking face is oriented downward (see FIG. 4 also).

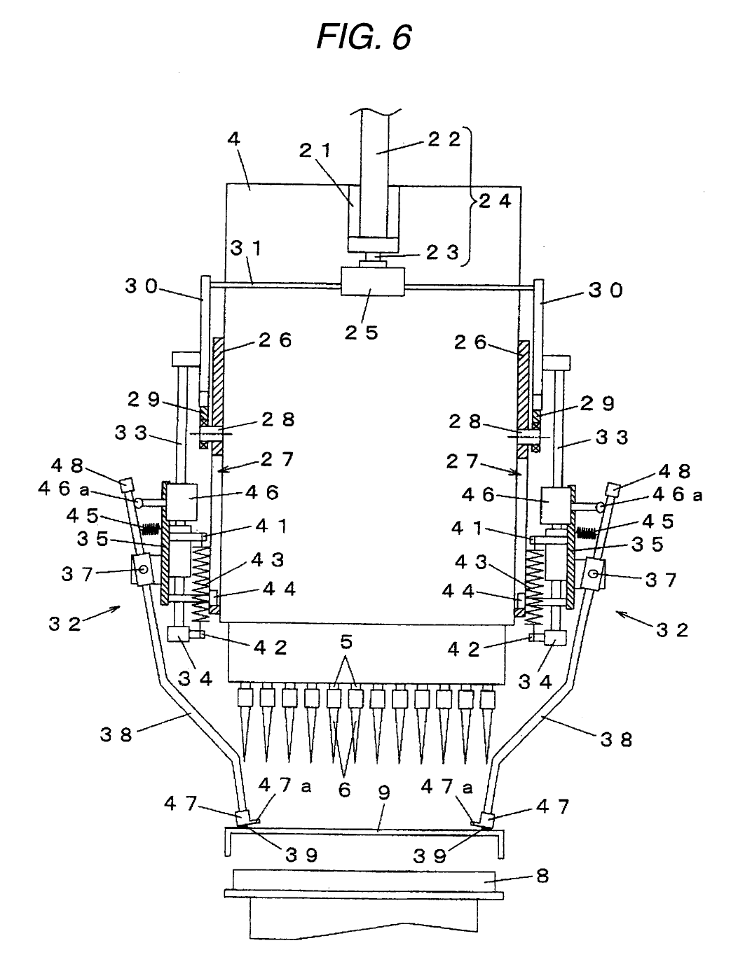

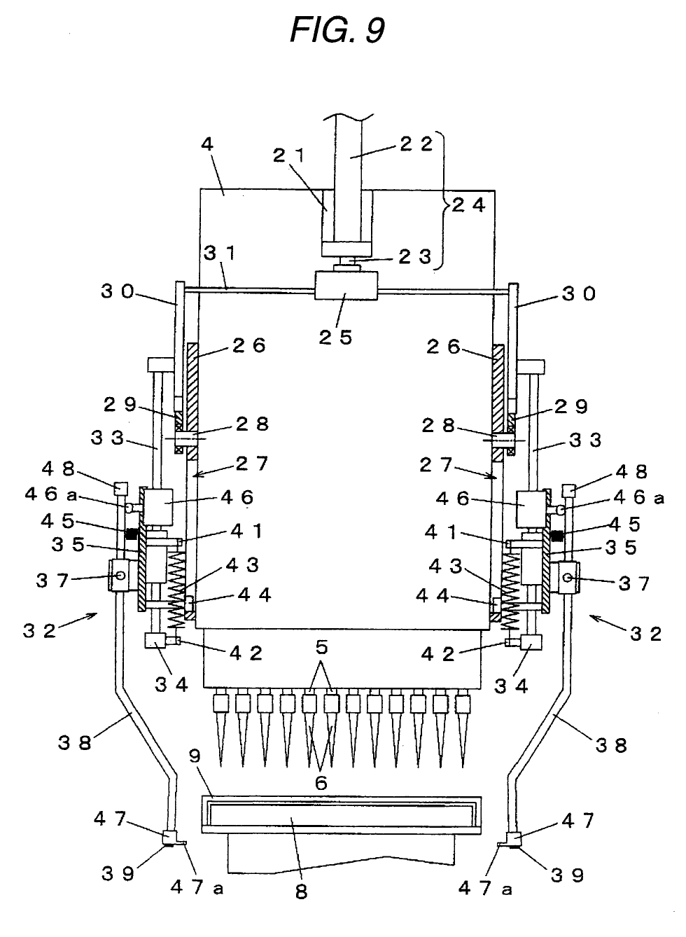

Referring to FIG. 3, the interval Wmax between the tips of the projections 47a of both end lids 47 when the quantity of outward projection of the pistons 46a of the arm opening/closing cylinders 46 is minimum is larger than the width Wo of the sample vessel 8 (this state is assumed as a state where the arms 38 are opened). The interval Wmin between the right and left sucking pads 39 when the quantity of outward projection of the pistons 46a of the arm opening/closing cylinders 46 is maximum is smaller than the width Wo of the sample vessel 8 (this state is assumed as a state where the arms 38 are closed). Additionally, in FIG. 3, the arms 38 illustrated to have the largest interval between both end lids 47 are shown in the state where the quantity of projection of the pistons 46a is minimum (this also applies to FIG. 9). The arms 38 illustrated to have the smallest interval between both end lids 47 are shown in the state where the quantity of projection of the pistons 46a is maximum (this also applies to FIG. 6).

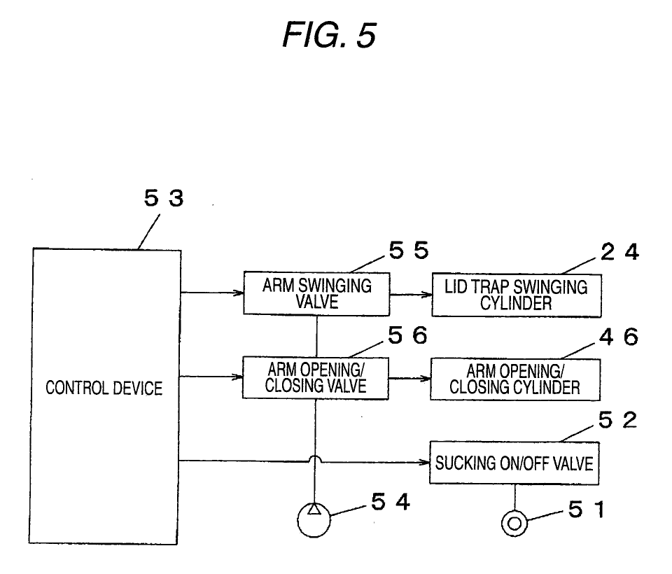

Each arm 38 is formed in a hollow pipe shape. Its interior constitutes a vacuum tube path connected to the sucking pad 39 from the end lid 47. To the upper end of each arm 38, a vacuum hose 49 is connected through a vacuum hose connecting piece 48. The vacuum hose 49 is connected to a vacuum source 51 (FIG. 5). Between the vacuum source 51 and the vacuum hose 49, an sucking on/off valve 52 is arranged. By operating the sucking on/off valve 52 from a control device 53 included in the dispenser 1, a vacuum sucking force can be generated on the lower sucking surface of the sucking pads 39 (sucking “ON”), or otherwise the vacuum sucking force generated can be released (sucking “OFF”).

In this dispenser 1, by the expanding/contracting operation, the lid trap swinging cylinder 24 swings the right and left lid traps 32 within the back-and-forth planes of the dispensing head 4. In an air path (not shown) connecting the lid trap swinging cylinder 24 and an air source 54 (FIG. 5), an arm swinging valve 55 is arranged. By operating the spool of the arm swinging valve 55 from the control device 53 so that the path of the air supplied from the air source 54 to the lid trap swinging cylinder 24 is changed, the expanding/contracting operation of the lid trap swinging cylinder 24 can be performed.

Further, in the dispenser 1, the arm opening/closing cylinders 46 swing the arms 38 within the right-and-left planes of the dispensing head 4 through the protruding/sinking operation of the pistons 46a. In an air path (not shown) connecting the arm opening/closing cylinders 46 and the air source 54, an arm opening/closing valve 56 is arranged. By operating the spool of the arm opening/closing valve 56 from the control device 53 so that the path of the air supplied from the air source 54 to the arm opening/closing cylinder 46 is changed, the projecting/sinking operation of the pistons 46a of the arm opening/closing cylinders 46 can be performed (FIG. 5).

In the dispenser 1 having the structure described above, prior to dispensing the sample into the sample vessel 8 by the dispensing head 4, using the lid traps 32, the lid 9 can be removed from the sample vessel 8 and while the dispensing is executed, the removed lid 9 remains moved sideward (rearward) of the dispensing head 4. Upon completion of the dispensing by the dispensing head 4, the lid 9 can be returned onto the original sample vessel 8 so that dust or rubbish does not enter the sample vessel 8. Now referring to FIGS. 6, 7 and 8, an explanation will be given of the operation of the lid traps 32 of removing the lid 9 from the sample vessel 8 to move it sideward of the dispensing head 4 and returning the lid 9 moved sideward of the dispensing head 4 to the original sample vessel 8.

In order to dispense the sample into the sample vessel 8 using the dispensing head 4, first, the dispensing head 4 is moved immediately above the sample vessel 8 with the lid 9 put on the upper surface (on the upper surface of which the lid 9 is placed). By controlling the operation of the arm opening/closing valve 56 from the control device 53 so that the quantity of projection of the pistons 46a of the arm opening/closing cylinders 46 becomes maximum, both arms 38 are placed in the closed state. Further, lowering the dispensing head 4 so that sucking pads 39 at the lower ends of both arms 38 are pressed against the upper surface of the lid 9. By controlling the operation of the sucking on/off valve 52 from the control device 53, the vacuum sucking force is generated on the sucking plane of the sucking pads 39 so that the lid 9 is sucked. Thus, the lid 9 is placed in a state trapped by the lid traps 32. Subsequently, by raising the dispensing head 4, the lid 9 can be removed from the sample vessel 8.

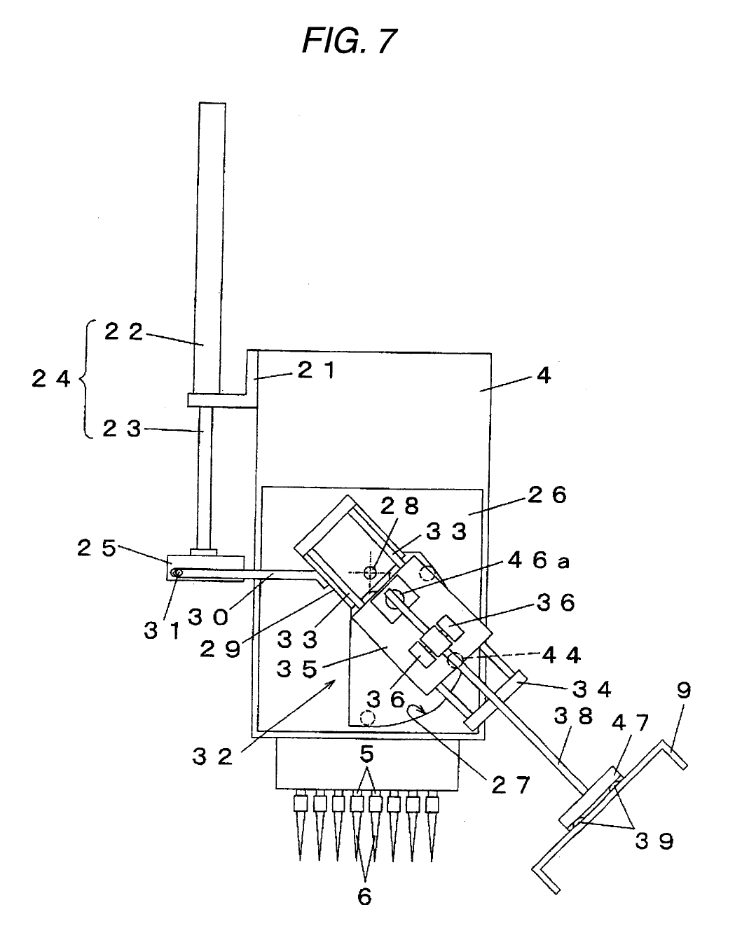

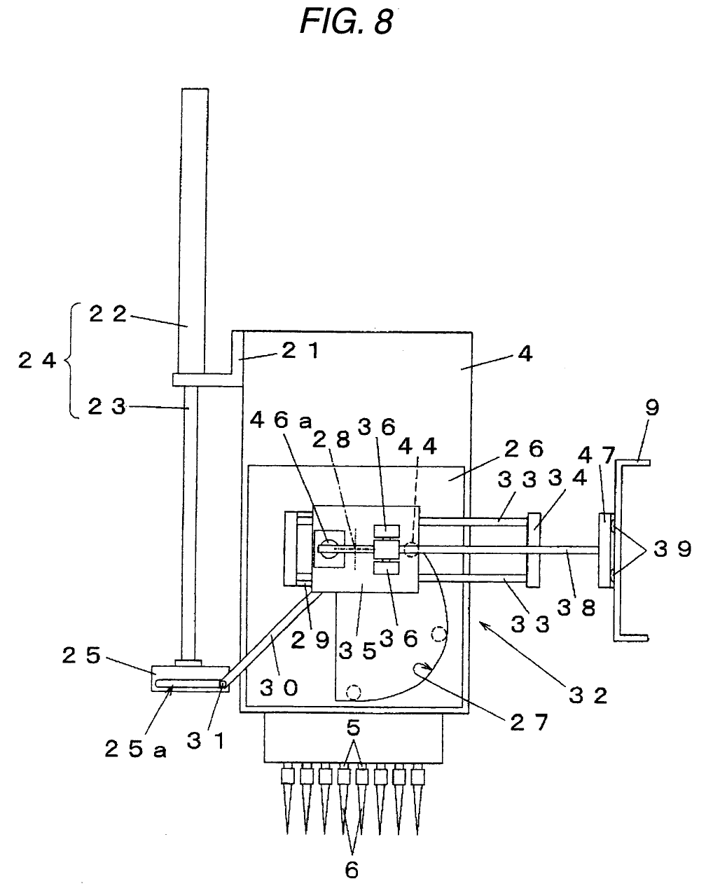

After the lid 9 has been removed from the sample vessel 8, by controlling the operation of the arm swinging valve 55 from the control device 53 so that lid trap swinging cylinder 24 is expanded to upward swing the swinging plates 29 through the horizontal member 31 and levers 30 around the pivoting pins 28. Thus, the right and left arms 38 swing around the pivoting pins 28 from the initial posture dangling downward (at this time, the cam followers 44 are located immediately below the pivoting pins 28. See FIG. 4) to reach the horizontal posture (see FIGS. 7 and 8). Thus, the lid 9 trapped by the lid traps 32 moves sideward (rearward) of the dispensing head 4.

On the way from the initial posture of the right and left arms 38 dangling to the horizontal posture thereof, the slide plates 35 supporting the respective arms 38 slide on the guides 33 while moving the cam followers 44 along the inner peripheral edges of the cam grooves 27. In this case, the distance from the pivoting pins 28 to the inner peripheral edges of the cam grooves 27 becomes short as the swinging angle increases from the dangling posture of the arms 38 increases. For this reason the slide plates 35 slide-move on the guides 33 so that the lid 9 trapped is brought near to the dispensing head 4 as the arm 38 rears the horizontal from the initial posture.

In this way, when the lid 9 trapped by the lid traps 32 are moved sideward of the dispensing head 4, the lid 9 retreats from the lower ends of the dips 6 serving as dispensing openings, which results in the state where the dispensing head 4 can dispense the sample into the sample vessel 8 (respective wells 8a). While keeping the state where the lid 9 has retreated sideward of the dispensing head 4, the sample is dispensed into the sample vessel 8 by the dispensing head 4.

Upon completion of dispensing the sample into the sampling vessel 8 by the dispensing head 4, the lid 9 is returned to the original sample vessel 8 in the procedure reverse to that when the lid 9 is moved sideward of the dispensing head 4. To this end, by controlling the operation of the arm swinging valve 55 from the control device 53 so that the lid trap swinging cylinder 24 is contracted to downward swing the swinging plates 29 around the pivoting pines 28 through the horizontal member 31 and the levers 30. Thus, the right and left arms 38 swing around the pivoting pins 28 from the horizontal posture to reach the posture dangling downward. As a result, the lid 9 trapped by the lid traps 32 moves to beneath the dips 6 from sideward of the dispensing head 4. So, by controlling the operation of the sucking on/off valve 52 from the control device 53 so that the vacuum sucking of the lid 9 by the sucking pads 39 is released, the lid 9 can be returned to the original sample vessel 8. In this way, in the dispenser 1 according to the embodiment of this invention, a series of operations from removal of the lid 9 prior to dispensing to the dispensing and return of the lid 9 after the dispensing can be smoothly performed.

Further, in this dispenser 1, the sample vessel 8 sandwiched by the opening/closing operation of the right and left arms 38 (swinging operation in the right-and-left direction of the dispensing head 4) can be transported to a desired position. In this case, it is not necessarily required that the sample vessel 8 is provided with the lid 9.

To this end, first, the dispensing head 4 is moved immediately above the sample vessel 8. Next, by controlling the operation of the arm opening/closing valve 56 from the control device 53 so that the quantity of projection of the pistons 46a of the arm opening/closing cylinders 46 is minimum, both arms 38 are placed in their opened state. Further, the dispensing head 4 is lowered so that the projections 47a of the end lids 47 attached to the lower ends of both arms 38 are located below the sample vessel 8 (FIG. 9). By controlling the operation of the arm opening/closing valve 56 from the control device 53 so that the pistons 46a of the right and left opening/closing cylinders 46 are projected outwardly of the dispensing head 4, both arms 38 are driven in their closed direction. Thus, the sample vessel 8 is sandwiched by the end lids 47 of both arms 38. From this state, if the dispensing head 4 is raised, the projections 47a of the end lids 47 of both arms 38 are brought into contact with lower surface of the sample vessel 8 from below thereby to scoop up it. This results in a state where the sample vessel 8 can be transported stably by both arms 38. From this state, if the dispensing head 4 is moved, the sample vessel 8 can be transported to a desired position.

As understood from the description hitherto made, the dispenser 1 according to this embodiment includes a dispensing head 4 for dispensing the sample to the sample vessel 8 by moving relatively to the sample vessel 8, lid traps 32 attached to the dispensing head 4 for trapping the lid 9, and a lid trap swinging cylinder 24 (lid trap driving means) for driving the lid trap 32 to move the lid 9 trapped by the lid traps 32 sideward of the dispensing head 4. Therefore, while the sample is dispensed into the sample vessel 8 by the dispensing head 4, the lid 9 trapped by the lid traps 32 prior to dispensing can be left moved (retreated) sideward of the dispensing head 4. Thus, a series of operations from removal of the lid 9 prior to dispensing to the dispensing and return of the lid 9 after the dispensing can be smoothly performed so that the dispensing for the sample vessel 8 equipped with the lid 9 can be done effectively in a short time. Further, since the lid 9 removed from the sample vessel 8 prior to the dispensing is necessarily returned to the original sample vessel 8, the sample within the sample vessel 8 put on the lid 9 will not be mixed in another sample.

Further, in the dispenser 1 according to this embodiment, the lid traps 32 have the arms 38 freely swingable for the dispensing head 4. When the arms 38 are driven by the lid trap swinging cylinder 24 to swing for the dispensing head 4, they operate to bring the trapped lid 9 near to the dispensing head 4. For this reason, the quantity of overhanging of the lid 9 from the dispensing head 4 after moved sideward of the dispensing head 4 can be decreased.

Further, in the dispenser 1 according to this embodiment, the arms 38 are provided as a pair on both sides of the dispensing head 4 and the arm opening/closing cylinders 46 (arm opening/closing means) are provided to cause the lower ends of these pair of arms 38 to open/close to sandwich the sample vessel 8. For this reason, not only the detachment/attachment of the lid 9 put on the sample vessel 8 but also the transportation of the sample vessel 8 itself by the movement of the dispensing head 4 can be done.

Although this invention has been explained hitherto with reference to its embodiment, it should not be limited to the embodiment explained. For example, in the embodiment explained, the configuration was adopted in which the lid 9 is trapped by sucking using the sucking pieces (sucking pads 39) provided on the lower parts of the two arms 38 dangling from both sides of the dispensing head 4, but another configuration may be adopted in which the lid 9 is trapped by opening/closing the two arms 38. However, like this embodiment, where the lid 9 is moved sideward of the dispensing head 4 by swinging of the arms 38 after the lid 9 is trapped, the configuration using the sucking pads 39 lidable of surely trapping the lid 9 is preferred.

In the embodiment described above, the configuration was adopted in which the pair of arms 38 are caused to dangle on both sides of the dispensing head 4 and the sucking pieces (sucking pads 39) are formed on the lower ends of the respective arms 38. However, another configuration may be adopted in which the lower ends of the two arms dangling from both sides of the dispensing head 4 are coupled with each other by a horizontal coupler laterally extending below the dispensing head 4 and a sucking pad is formed on the lower surface of the coupler. Otherwise, still another configuration may be adopted in which one arm dangling from the one side of the dispensing head 4 is bent at its lower end to constitute the horizontal member laterally extending below the dispensing head 4 and the sucking pad is formed on the lower surface of the horizontal member.

Further, in the embodiment described above, the configuration was adopted in which the lid traps 32 have the arms 38 freely swingable for the dispensing head 4 and the arms 38 are swung for the dispensing head 4 thereby to move the lid 9 sideward of the dispensing head 4. However, as long as the lid traps are driven by the lid trap driving means thereby to move the trapped lid 9 sideward of the dispensing head 4, another configuration may be adopted in which the lid traps have the horizontal members extending from the dispensing head 4 and vertical members dangling therefrom and the vertical members are slide-moved along the horizontal members thereby to move the lid 9 sideward of the dispensing head 4.

### INDUSTRIAL APPLICABILITY

The dispensing for a sample vessel equipped with a lid can be done effectively in a short time. Further, it is possible to prevent the sample within the sample vessel put on the lid from being mixed into another sample.

This application is based upon and claims the benefit of priority of Japanese Patent Application No. 2006-318261 filed on Nov. 27, 2007, the contents of which are incorporated herein by reference in its entirety.

1. A dispenser for dispensing a sample in a sample vessel equipped with a removable lid in a state where the lid is removed, comprising:
a dispensing head for dispensing the sample into the sample vessel by its movement relative to the sample vessel;
a lid trap attached to the dispensing head for trapping the lid; and
a lid trap driving means for driving the lid trap to move the lid trapped by the lid trap sideward of the dispensing head.

2. A dispenser according to claim 1, wherein said lid trap has an arm swingable for the dispensing head, and said lid trap driving means swings the arm for the dispensing head thereby to move the lid tapped by the lid trap sideward of the dispensing head.

3. A dispenser according to claim 2, wherein when said arm is driven by the lid trap driving means to swing for the dispensing head, it operates to bring the trapped lid near to the dispensing head.

4. A dispenser according to claim 2, wherein said lid trap traps the lid by sucking using a sucking piece formed at the lower end of the arm.

5. A dispenser according to claim 3, wherein said lid trap traps the lid by sucking using a sucking piece formed at the lower end of the arm.

6. A dispenser according to claim 2, wherein said arm is provided as a pair of arms on both sides of the dispensing head, and an arm opening/closing means is provided to open/close the lower ends of the pair of arms to sandwich the sample vessel.

7. A dispenser according to claim 3, wherein said arm is provided as a pair of arms on both sides of the dispensing head, and an arm opening/closing means is provided to open/close the lower ends of the pair of arms to sandwich the sample vessel.
